(19) United States
(12) Patent Application Publication
(10) Pub. No.: US 2008/0216145 A1
(43) Pub. Date: Sep. 4, 2008

(54) System and Method for Media Transmission

(76) Inventors: Jason Shawn Barton, Chesapeake, VA (US); James David Barton, Suffolk, VA (US)

Correspondence Address: DUNCAN G. BYERS PC, 142 W. York Street, Suite 910, NORFOLK, VA, 23510, US

(21) Appl. No.: 11/968,153

(22) Filed: Dec. 31, 2007

Related U.S. Application Data
(60) Provisional application No. 60/882,945, filed on Dec. 31, 2006.

(51) Int. Cl. H04N 7/173; H04N 7/167

(52) U.S. Cl. 725/131; 380/210

(57) ABSTRACT

System and method for transmitting and protecting media data set in a data communication medium. The invention provides encryption of media data and authorization prior to the media data being accessible on the end-user device. A Set Top Box provides for storage of media data downloaded through an access point, with security structures built in to the downloaded media data. The Set Top Box sends media data through a network to end-user devices that are recognized as authorized end-user devices. The system may further include limitations on the availability of the media data at the end-user device based upon wired, wireless, physics-based and location based security.

This application claims the benefit of U.S. Patent Application No. 60/882,945 entitled “System and Method for Media Transmission,” filed on Dec. 31, 2006.

### BACKGROUND OF THE INVENTION

The present invention relates in general to file distribution, and more particularly to systems and methods for transmitting media data in a manner that allows the data content to be protected from theft by unauthorized reproduction or other means. The invention allows an authorized end-user to access media data with location-based encryption and authorization. More particularly, the present invention limits access to the end use of media by providing encryption that may limit the use and/or reproduction of the media through the use of location restrictions, reproduction restrictions, restrictions of playback to authorized end-use devices or duration of access restrictions, or restrictions upon the number of times the media may be accessed for playback.

There is a significant demand for media of all types, including movies, music, etc. that is provided over wired, wireless network, and other data communication services. More and more consumers choose to receive media electronically rather than through the purchase or rental of movies, music and the like on hard, fixed storage such as CDs, DVDs and HD DVDs. However, providing such media data content electronically rather than on traditional, fixed storage means opens up opportunities for abuses of such services and outright theft of electronic versions of movies and music. The owners of copyrights on electronic or digital data have a need to police and protect their copyrights and other intellectual property rights.

Previous means of protection have included strong encryption, digital watermarks and other forms of unique identification or access control, but such protections have proven to be generally inadequate. Once broken, the encryption, watermark and other known forms of protection cannot prevent an end-user from duplicating or impermissibly distributing proprietary data content. A significant limitation to such means of protection is that the protection is static and is incorporated into the data at the source; once the content is delivered to the end-user, the media provider no longer has control of the use of proprietary media. The need for methods of securing such data content must be weighed against the need for access by the paying customer, however. A customer needs to have freedom to enjoy the media that they have purchased, while at the same time the owner of the data content needs to be provided means for protecting its proprietary data content. It is particularly difficult to balance the need for protection against the need of the consumer to have fast and ready access to and transmission of the media that the consumer has purchased. In addition, the ability to play back media has expanded to a large number of available devices, including dedicated devices such as Apple's® iPod® and other portable media playback devices, as well as non-dedicated devices that provide media playback as an additional function, such as cellular telephones and personal data organizers. Personal computers themselves are becoming increasingly portable, and many consumers choose to use personal computers to access and enjoy various media available to them. The source and type of media data content has become largely irrelevant; digital media is currently available via satellite feeds and home entertainment systems have expanded to include digital media recording devices that allow time-shifting of broadcast and other media data content.

Previous means of providing data content security have required that the security means be embedded or somehow otherwise attached to the data content either at the point of sale, point of distribution, or earlier. Once out of the hands of the data content provider, monitoring and maintaining the security of the media data content becomes difficult if not impossible. What is needed is a way of providing fast and secure data content to an end-user who may playback the media data content through a multitude of playback means while providing data content security at the point of end-user access rather than at the point of distribution or sale.

Accordingly, the present invention provides a way to control the distribution of digital and other media once the data content has been purchased by an end-user. More particularly, the present invention allows for the transfer of digital data content to an end-user via point of access authentication and encryption, and playback and access capability on numerous customer-owned devices while providing for on-the-fly purchase verification, playback restrictions based upon physical location, and embedded point-of-access security rather than point of sale security. It is a further object of this invention to provide to the owner and/or distributor of digital media data content the ability to control access and update security at the end-user access point rather than having a one-time security protocol embedded in or associated with the media data content.

### SUMMARY OF THE PRESENT INVENTION

Media files are stored in a data content repository. A customer accesses the media files through an Access Point (AP) which connects to the media data content provider. Through the AP, a customer can browse the available media through a list, search engine, or other means determined by the media host. Once the customer has determined what media they would like to receive, the system detects the consumer's device type that the purchased data content will be downloaded onto and/or on which the media data content will be viewed. For example, the end consumer may be viewing or listening to the received media data content on a mobile phone, a portable video viewing device, a computer (e.g., desktop or laptop personal computer, etc.), download for “burning” onto another storage medium, such as DVD or CD, or a device that provides media data content to a television or other output device such as a sound system. The customer's request for particular media data content is authorized through the AP according to the terms of the sale and/or lease of the data content, and the media data is transmitted via network or other connection to a Set Top Box (STB) at the purchaser's location. The STB will provide the consumer with the ability to authenticate playback of purchased media in numerous formats for numerous end uses, while allowing the content provider to control not only the access to media content, but also provide a means whereby the content provider can control security of the provided content at the point of use.

The media data content delivery to the consumer may be accomplished by various means. Online (internet) media downloads or wired, wireless, satellite, etc. connections may be used, while the data content may also be physically delivered in media format such as DVD, CD, or other hard physical storage means. Once the media is delivered to the consumer, it is stored on some readily-accessible device, generally a hard drive or the like. Security may be provided at the STB, and may be upgraded as the consumer accesses the media data content and/or via “push” by the media provider through the Access Point. As discussed in detail below, the security may be based upon a number of desired limit actions such as location (i.e., proximity of a playback device to the AP) or repetitive playback limitations. The media data content is accessed through the AP by which the consumer either views the data content or transfers the data content to a fixed portable or semi-portable playback device.

### BRIEF DESCRIPTION OF THE DRAWINGS

FIG. 1 shows an example of the Access Point (AP) Secure Data content Distribution Model in accordance with an embodiment of the present invention.

FIG. 2 shows an example of the Access Point (AP) Location Security Logical Flow in accordance with an embodiment of the present invention.

FIG. 3 shows an example of the importation of data content into a personal library in accordance with an embodiment of the present invention.

FIG. 4 shows a method of synchronizing the Access Point (AP) with the Access Control List (ACL) in accordance with an embodiment of the present invention.

FIG. 5 shows details of a consumer purchase of media data content in accordance with an embodiment of the present invention.

FIG. 6 shows an example of registering an end-user device within a Personal Data Content Delivery Network (CDN) in accordance with an embodiment of the present invention.

FIG. 7 shows a method of playing data content within a personal data Content Delivery Network (CDN) in accordance with an embodiment of the present invention.

### DESCRIPTION OF A PREFERRED EMBODIMENT

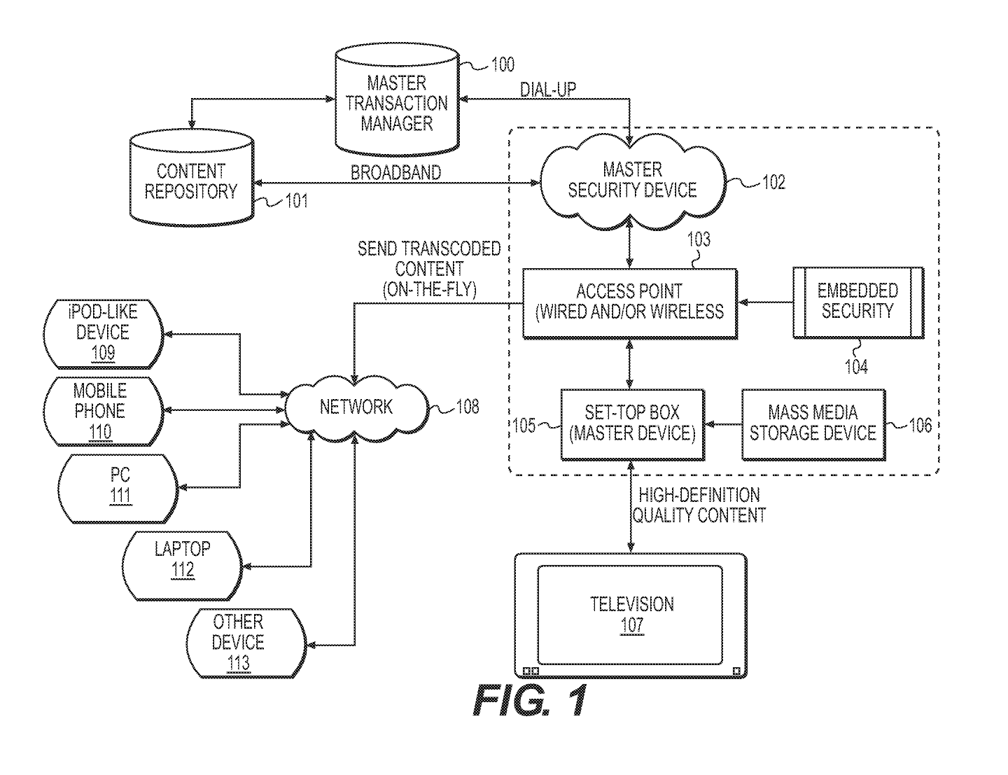

Referring now to the embodiment of the invention illustrated in FIG. 1, the method utilizes a Master Transaction Manager (MTM) 100 to control transfer of media data from the Data Content Repository 101 to a Master Security Service (MSS) 102. Media data content is transferred through the Access Point (AP) 103 to a Set Top Box (STB) 105, with the data in digital, analog, or other electronic format stored in a Mass Media Storage Device 106. In a preferred embodiment of the present invention, the Set Top Box should be understood to be that combination of interface means for a user to browse and access data while providing local security encryption and other security means for the content provider.

The AP 103 may be connected to the MSS 102 via wired, wireless or other connection through either/or the MSS 102 and the local network 108. The AP 103 serves as the primary communication hub through which: 1) media data content is delivered to an end-user's local storage device; 2) the end-user accesses the downloaded media data content; and 3) authorization is verified and security for the data content maintained and updated as needed or desired. The embedded security 104 in the AP 103 may be either hard-wired or software based, and is controlled by the MSS 102 as noted above. The MSS 102 communicates at set intervals or on demand with the AP 103, ensuring that the security protocols are up to date, being enforced, and have not been compromised. The AP 103 itself may comprise either singly or in combination either a mechanical gateway or software gateway for the transfer of data requests to the MTM 100 through the MSS 102. The AP 103 may have the MSS 102 incorporated into it as on-site security protocols. In addition, the AP 103 may be a stand alone device (such as current internet wired or wireless hubs) or may be integrated with the Set Top Box (STB) 105, which may further be integrated with the Mass Media Storage Device (MMSD) 106. Various combinations will be understood, although it is contemplated that the STB 105 may be provided either as a hardware or software solution on consumer devices such as game consoles, cable modems and the like. Such solutions may be provided either pre- or post-sale of such devices to a consumer. In the event that security protocols detected on the consumer device do not match the security protocols as recognized by the MSS 102 and/or the AP 103, delivery and/or playback of media will be interrupted, and not allowed until the consumer device security protocols are recognized by the MSS 102.

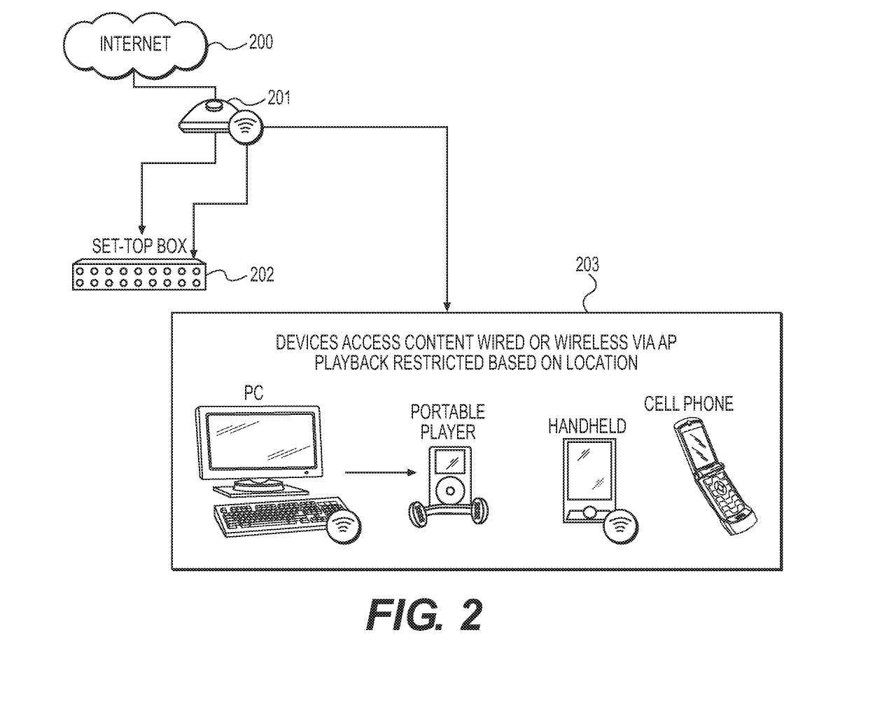

Data content stored on the MMSD may be updated, removed, and accessed as on any other comparable mass storage device. The media data content is transcoded (as discussed below in the description of FIG. 2) for the particular end-user device chosen by the consumer. The end-user may play the media data content through a television 107 or other non-portable end-user device. In addition, on-the-fly transcoded data content may be sent out over a local network 108 through the AP 103 to end-user devices capable of video or music playback such as the Apple® iPod® 109 and similar devices, a mobile telephone 110, a personal computer 111, a laptop or portable computer 112, or other device 113 capable of replay of the media data. Each transaction for the purchase and/or rental of the media data is sent to the MTM 100 by the STB 105. The embedded security 104 supports all known security, including but not limited to wired, wireless, physics-based and location-based security, and may be upgraded as security protocols are upgraded and/or replaced. The MTM 100 controls not only how and when media is sent through the Access Point 103, but also identifies the end-user and playback device for the Master Security Service (MSS) 102 so that appropriate security protocols are chosen based upon the details of the transaction between the consumer and the data content provider as well as the details of the intended end use of the media data content. For example when location based security is desired, the MTM 100 notifies the MSS 102 and the MSS 102 then provides encryption with the media data content that limits playback of the media to within physical proximity of the signal available to the final playback device (see description below in FIG. 8). In this example, a device such as a desktop computer is initialized as a playback device, and the content security only allows playback so long as the desktop computer is in close enough proximity to the STB 105 such that wireless or similar transmitted signals may be sent and received between the playback device and the STB 105.

FIG. 2 illustrates an AP Location Security Logical Flow. The end-user (consumer) has access to media data content via the internet 200 or some other data transfer means through the AP 201. The AP 201, as described above, may be wired, wireless, or utilize another connection means, and provides the location based encryption and location based authorization discussed in more detail below. The AP 201 may further be any device capable of receiving and transmitting information and media data content through the data transfer means being utilized at the time. The STB 202 communicates with and through the AP 201, and the STB 202 may provide data content storage as well as transcoding of data content. As discussed below, the STB 202 may be a physically independent hardware device that may physically incorporate the AP 201. In the alternative, the STB 202 may also comprise a hardware or software utilization of existing hardware such as the storage media found in newer stand-alone home video gaming systems, existing wireless or wired internet access devices, or other devices, singly or in combination, that have either built-in functions that allow access to the internet and the transfer of media data content or which may be upgraded to such capability through the addition of either hardware or software. For example, the STB 202 may comprise software provided to an end-user as an add-on to devices that an end-user already possesses. The STB 202 may also be hardware retrofitted to existing hardware devices possessed by an end-user. The STB 202 may further comprise hardware and/or software coded into such devices prior to sale to an end-user, and be available to the end-user as a further capability should they choose to utilize the service after purchase of the device. As an example, some recent home stereo designs incorporate the capability to receive and manage data content downloaded from internet and satellite resources. It will be obvious to one skilled in the art that the wired and/or wireless connectivity does not depend upon current state of the art, and should be understood to include expansion into other modes of data content transmission to an end-user.

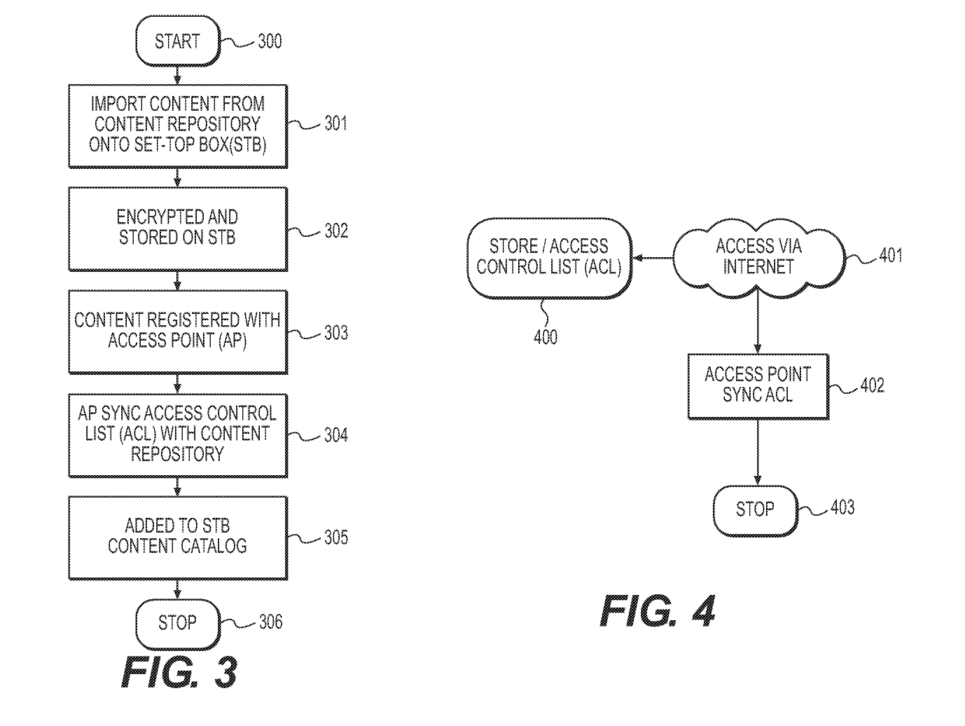

FIG. 3 shows a method of encrypting and importing data content into a personal (end-user) content catalog located within the Set Top Box. In an initial operation 300, the operations shown in FIG. 1 wherein data requests are made by an end-user and the requested data set is retrieved from the data content repository 101 by the Master Transaction Manager (MTM) 100, and the data content is imported 301 to the Set Top Box (STB) 105. The data content is encrypted (by the embedded security 104 in FIG. 1) cataloged and stored 302 on the STB 105 in FIG. 1. The data content imported 301 to the STB 105 may be imported from numerous sources and by various means. For example, as discussed above, the data content may be delivered via wired, wireless, and other means. In addition, the data content may be imported to the STB 105 from mass storage media such as CD, DVD, and HD DVD and made available to the end-user through the end-user's content catalog that is resident in the STB 105. The data content is registered with the Access Point (AP) 303; all data content sets must be registered as data content that has been purchased by the end-user and added to a security policy, in this case a Access Control List (ACL). Without registration, the data content cannot be played back by the end-user; the ACL authenticates the end-user device against existing end-user contracts and/or licenses resident within and managed by the Master Security Service 102 and thereby confirms the purchase of the contract and/or license prior to playback. The contract and/or license information is preferentially maintained by the data content vendor. The AP 303 in turn synchronizes 304 the ACL with the data content retained by the vendor on the vendor's ACL (shown in detail in FIG. 4), and the data content is added 305 to the STB FIG. 1 105 data content catalog. At this point the importation of the data content ends 306, and the data content is available for transfer to authorized end-user devices for playback.

FIG. 4 shows detail of FIG. 3 304 wherein the AP ACL is synchronized 402 with a vendor's ACL 400. The AP ACL accesses 401 the vendor's ACL 400 via the internet. As noted above, it will be understood that there are many methods available to transfer the authorization data and data content that are equivalent of the internet method. A vendor's ACL 400 will generally comprise security restrictions such that only end-users whose purchase has been registered on the vendor's ACL 400 will be provided with permissions for playback of the media data content. The access point ACL 402 includes a configurable Time-to-Live (TTL) security policy. The TTL security policy includes protocols for discarding data that has been available for a period of time or amount of uses exceeding set security parameters. The TTL security policy may be based upon such things as time (any frequency of time), confirmation of purchase of the media data, and refreshing events instigated either by the end-user (such as by access to the Set Top Box) or by the content provider via a “push.”

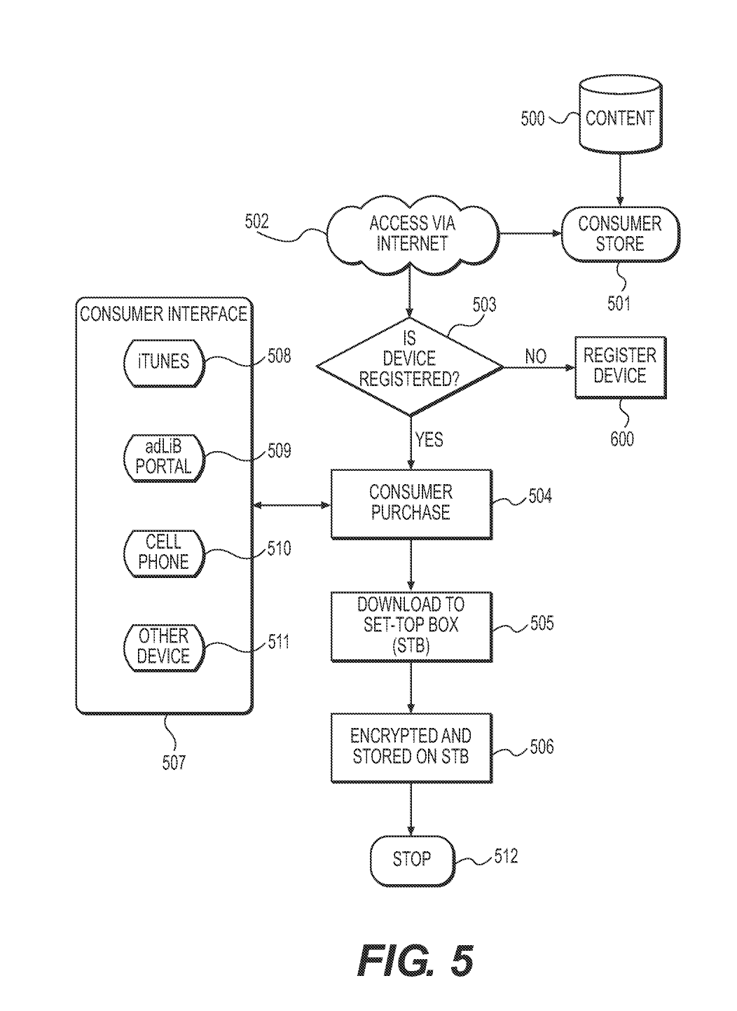

FIG. 5 shows details of a consumer purchase wherein the data content 500 is retained by or accessible to a consumer store 501. A consumer accesses 502 the consumer store 501 via the internet or some other remote means as discussed above; at the point of consumer purchase, the consumer interface 507 is either determined by the system or identified by the consumer and may include data content formats that support such end uses as iTune® devices 508, adLib portals 509, cell phones 510, or other devices 511 intended to or used for the playback of digital media data content. The data content 500 that has been formatted either prior to the purchase or at the time of the purchase is downloaded 505 to the Set Top Box (STB). As discussed above, the STB may be any device capable of receiving and storing data content, either as a stand-alone unit, as dedicated hardware in a device that is not dedicated to the playback of digital media; for example, the STB can be software that utilizes existing non-dedicated hardware (such as the existing hardware capabilities of electronic game devices) or any combination thereof. The data content 500 is encrypted and stored 506 on the STB, available for playback when the consumer desires, and the process shown in this Figure stops 512. The formatting of the data content for a particular user device may occur either prior to delivery of the content by a content provider, or the data content may be provided to the STB as a master file to be stored locally on the STB and accessed on-the-fly by the consumer.

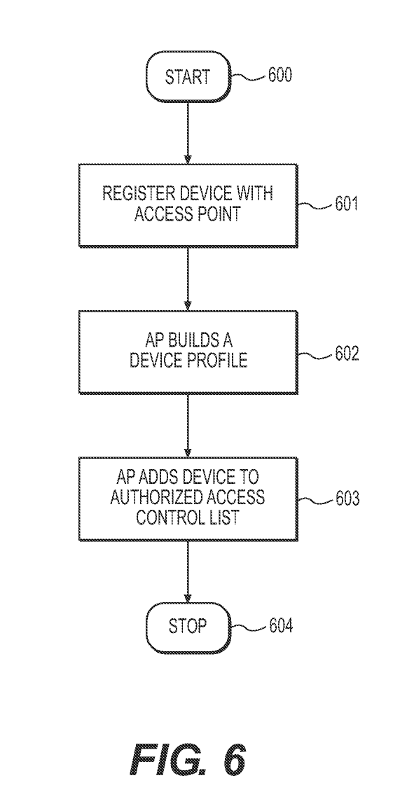

FIG. 6 shows details of a consumer purchase wherein the consumer's playback device is registered within a personal Data content Delivery Network (CDN). At the start 600 of the process, a consumer registers an end-user device 601 with the Access Point. As discussed above, such end-user devices may include such devices as a portable video or music device (i.e., the Apple® iPod®), a mobile telephone, a personal computer, a laptop or portable computer, or other device capable of replay of the media data content. Based upon the attributes of the device either detected by the system or provided by the end-user, including but not limited to the type of device, supported media formats, video quality attributes such as size, resolution, and compression factors the AP builds a Device Profile 602. The Device Profile 602 is then added 603 to the Access Control List to manage authorized distribution and playback to the device. The device registration is now complete 604 allowing playback of data content by a consumer.

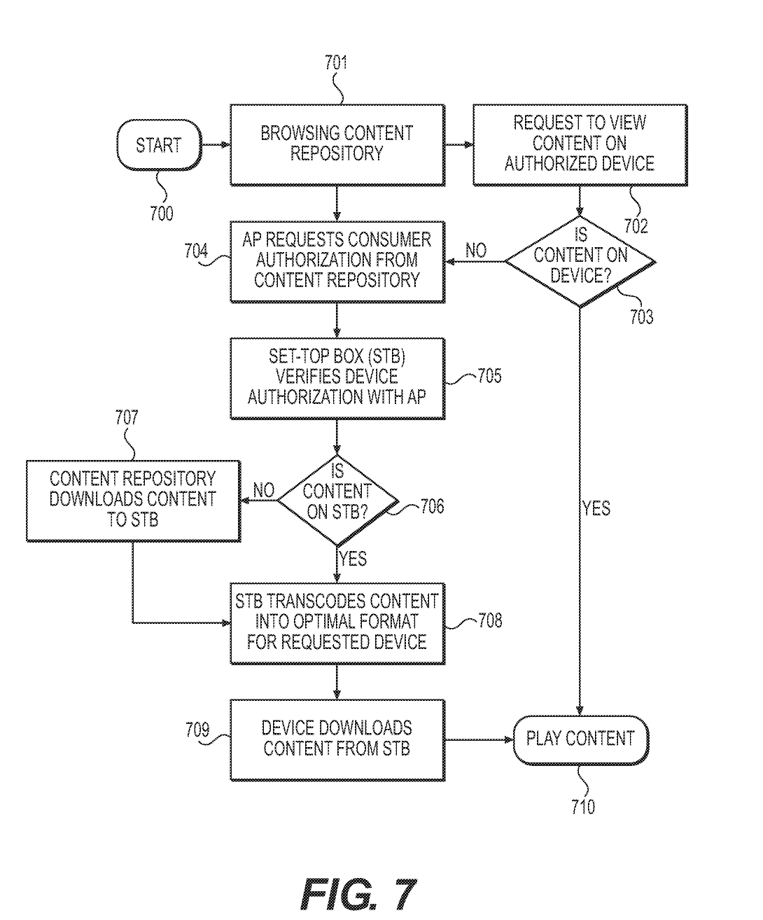

FIG. 7 shows details of a consumer's playback of data content within a Personal Data Content Delivery Network wherein a consumer browses available data content in a Personal Library and may download the data content to a device that has been registered as shown in FIG. 6 for playback. A consumer starts 700 the playback process by browsing 701 available media data content on the STB, and chooses desired media data content. The consumer then 702 requests to view the chosen data content on an authorized device. If the data content is resident on the authorized device 703, the data content will play 710. Otherwise, the AP requests end-user device authorization from the Data Content Repository 704. Once the end-user device has been authorized, the STB verifies 705 the device authorization with the AP. If the data content is not on the STB 706, the data content is downloaded from the data content repository onto the STB 706. Once the device has been authorized and the data content is resident on the STB, the STB transcodes the data content into an optimal format for the requested device 708. For example, video format and resolution will be different for a laptop versus a cell phone, and the data content is transcoded accordingly. The data content is then downloaded to the device end-user 709 for play 710.

The embodiments discussed above shows access to a vendor's ACL via the internet, but it should be understood that access may be by any communication means that allows confirmation of an end-user's purchase of the media requested for playback, including such things as dial-up connection via standard telephone lines and/or via cellular telephone service, wireless communications and/or wired communications, whether through dedicated services or not. One skilled in the art will also understand that the media data content may be transcoded to playback through any device capable of playing music, video, or other media. These devices may include televisions (as noted above), stereos and other non-portable devices.

In one embodiment, the end-user transfers the media file in an appropriate format to a portable playback device, and embedded security protocols will limit the playback of the media data content. As noted, such limitations to the playback of data content may include limitations based upon range of the portable playback device from the access point, time limitations for how long the portable access device may play back the data content, limitations on the number of times the data content may be played back, and the like. Another embodiment may allow unlimited playback of the media data content, but require periodic synchronization with the access point to verify that the end-user utilizing playback of the media data content is, in fact, authorized to play back the media. Yet another embodiment may allow an end-user to make permanent hard copy of the media, such as onto recordable DVD, CD, or other portable permanent media data content storage devices, with security embedded into the portable permanent media data content storage device through the Access Point. The security embedded in the portable permanent media data content storage device may operate to limit copying of the data content, the numbers of times the data content may be played back from the portable permanent media data content storage, and/or incorporate other security limitations. One skilled in the art will also recognize that the Access Control List may be maintained or controlled by a different entity than the data content vendor. It will also be understood that the ACL may be substituted by another security policy ensuring that the end-user is authorized to playback the data content.

It will be understood by those skilled in the art that modifications and variations may be made to the disclosed embodiments while remaining within the spirit and the scope of the invention as described within the claims.

What is claimed is:

1. A method of providing encrypted data content to an end-user device, said method comprising the steps of: connecting an end-user device to an access point, said access point communicatively connected to a master transaction manager; generating an end-user device profile that comprises device type, media formats and attributes supported by an end-user device; authenticating an end-user device through the said access point to an end-user access list stored on a master transaction manager; receiving and processing a request for data content by an end-user device; exporting data content requested by an end-user from a content provider to a set top box wherein said set top box is communicatively connected to said access point and said set top box further comprises a media storage device; adding exported data content to a set top box data content library; encrypting exported data content; and formatting exported data content to comply with said end-user device profile.

2. The method of claim 1 wherein said encrypting is performed in accordance with encrypting parameters stored within said access point.

3. The method of claim 1 further comprising the step of communicating encrypted data content to an end-user device.

4. The method of claim 1 wherein data content is formatted for a end-user device prior to exporting said data content to said set top box.

5. The method of claim 1 wherein said data content located within the set top box is stored as a master media file and the master media file is transcoded to an end-user device compatible format within the set top box at the time that said data content is communicated to said end-user device.

6. The method of claim 1 wherein the set top box is an electronic device.

7. The method of claim 1 wherein the set top box comprises software installed on an electronic device.

8. The method of claim 1 wherein said end-user device profile is generated by and stored within said access point.

9. The method of claim 1 wherein said access point further comprises a data content catalog comprising a list of available data content.

10. The method of claim 9 wherein the set top box further comprises means for browsing the data content catalog.

11. The method of claim 1 wherein said data content located within the set top box is stored as a master media file and the master media file is encrypted by the set top box at the time that said data content is communicated to said end-user device.

12. The method of claim 1 wherein said step of encrypting further comprises choosing encryption from the group comprising location-based security restrictions and time-to-live security restrictions.

13. A set top box for providing encrypted data content to an end-user device, said set top box comprising: An access point comprising means for authenticating an end-user device to a content provider and processing searches and requests for data content between an end-user device and a content provider; Data storage means; Communication means to connect said access point and said content provider; Means for encrypting data content stored on said data storage means; and Means for communicating data content between an end-user device and said set top box.

14. The set top box of claim 13 wherein the set top box further comprises a master security service communicatively connected to said access point, said master security service comprising means for authenticating an end-user device to a content provider.

15. The set top box of claim 13 wherein said set top box further comprises means to generate a browsable content catalog of data content located on said data storage means.

16. The set top box of claim 13 wherein said means for encrypting data content stored on said data storage means further comprises means for restricting playback of data content, said means for restricting playback of data content is chosen from the group comprising location-based security restrictions or time-to-live security restrictions.

17. The set top box of claim 13 further comprising means for receiving updates and modifications to said means for encrypting data content.

18. The set top box of claim 13 wherein said set top box further comprises means for detecting end-user device profile information.

19. The set top box of claim 18 wherein end-user device profile information is chosen from a group consisting of end-user device type, media formats supported by the end-user device, and media quality attributes comprising file size, resolution, and compression factors.

20. The set top box of claim 13 wherein said data content communicated between said end-user device and said set top box consists of data configured in accordance with an end-user device profile.

21. A set top box for providing encrypted data content to an end-user device, said set top box comprising: An access point comprising means for authenticating an end-user device to a content provider and processing searches and requests for data content between an end-user device and a content provider; Means for detecting end-user device profile information chosen from a group comprising end-user device type, media formats supported by the end-user device, and media quality attributes comprising file size, resolution, and compression factors; Data storage means; Communication means to connect said access point and said content provider; Means for encrypting data content stored on said data storage means, said means for encrypting data content comprising means for restricting playback of data content; Means for receiving updates and modifications to said means for encrypting data content; Means for communicating data content between said end-user device and said set top box; A master security service communicatively connected to said access point, said master security service comprising means for authenticating an end-user device to a content provider; and Means for generating a browsable content catalog of data content located on said data storage means.

22. The set top box of claim 21 wherein said means for restricting playback of data content is chosen from the group comprising location-based security and time-to-live security restrictions.

23. The set top box of claim 21 wherein said data content communicated between said end-user device and said set top box comprises data configured in accordance with end-user device profile information.
